(19) United States
(12) Patent Application Publication
(10) Pub. No.: US 2026/0064086 A1
(43) Pub. Date: Mar. 5, 2026

(54) MOTOR CONTROL DEVICE, MOTOR CONTROLLER, AND MOTOR CONTROL METHOD

(71) Applicant: Hyundai AutoEver Corp., Seoul (KR)

(72) Inventors: Dong Hui LIM, Seoul (KR); Tae Kyun KIM, Seoul (KR)

(21) Appl. No.: 19/296,211

(22) Filed: Aug. 11, 2025

(30) Foreign Application Priority Data
Aug. 27, 2024 (KR) 10-2024-0115313

(51) Int. Cl. G05B 11/01; H02K 24/00

(52) U.S. Cl. CPC G05B 11/012; H02K 24/00

(57) ABSTRACT

Motor control devices and methods are described. According to one embodiment, a motor control device includes a resolver to calculates an angle of rotation of a motor in accordance with voltage sensing values from stator windings and a motor controller to calculate an angle of rotation for control by extrapolating the angle of rotation calculated by the resolver based on a time difference between a control timing and a voltage sensing timing of the resolver and to control the motor by using the angle of rotation for control.

### CROSS REFERENCE TO RELATED APPLICATION

This application claims the benefit of and priority to Korea Patent Application No. 10-2024-0115313, filed on Aug. 27, 2024, the entire contents of which are hereby incorporated herein by reference.

### FIELD OF TECHNOLOGY

The present disclosure relates to motor control.

### BACKGROUND

In permanent magnet synchronous motors (PMSMs), which are commonly used in eco-friendly vehicles, accurate detection of the rotor's position is crucial.

PMSMs require high-precision torque control, and accurate rotor position is essential in producing optimal torque by applying an electric current to the stator at the right time to generate optimal torque. Furthermore, detecting the exact position of the rotor minimizes losses in motor control and enables efficient use of energy. In electric vehicles, where precise speed control is required, knowing the exact position of the rotor is crucial for accurately controlling speed.

Devices used to measure the motor's position and speed include Hall sensors, encoders, and resolvers.

Hall sensors sense the positions of magnets to detect the position of the rotor. Although Hall sensors are relatively simple and inexpensive, they have limitations in high-precision control due to their low resolution.

Optical encoders detect rotational position using a pattern on a disk, while magnetic encoders detect the position of a magnet through a magnetic sensor. Encoders provide relatively high-resolution position information, enabling precise motor control.

Resolvers measure the angle of rotation of the motor using analog signals. Revolvers instantaneously provide absolute rotor position information, and are suitable for industrial and automotive applications due to their robustness and high reliability.

A motor device may include a motor controller that generates motor control signals, and a resolver may include a resolver calculator that calculates an angle of rotation of the motor. The motor controller and the resolver calculator may be configured as separate integrated circuits (ICs), and may have a control period and a sensing period, respectively, in accordance with their respective PWM (Pulse Width Modulation) signals.

Accordingly, a time difference may occur between the motor controller's control timing and the resolver's sensing timing. The time difference between the control timing and the resolver's sensing timing may create a difference between the angle of rotation of the motor that the controller detects through the resolver and the actual angle of rotation of the motor. This difference can lower the stability of motor control and cause torque ripple in the motor.

In particular, the control period of the motor controller can vary, and if the aforementioned time difference fluctuates due to this variation, the stability of motor control may be further reduced, and the torque ripple may become more pronounced.

### SUMMARY

Against this background, in one aspect, the present disclosure is directed to providing a motor control technology that can enhance the stability of motor control. In another aspect, the present disclosure is directed to providing a motor control technology that minimizes torque ripple in the motor. In yet another aspect, the present disclosure is directed to providing a motor control technology that allows the angle of rotation of the motor detected at a control timing to be more analogous to the actual angle of rotation of the motor.

In view of the foregoing aspects, an embodiment of the present disclosure provides a motor control device including: a resolver that calculates an angle of rotation of a motor in accordance with voltage sensing values from stator windings; and a motor controller that calculates an angle of rotation for control by extrapolating the angle of rotation calculated by the resolver based on a time difference between a control timing and a voltage sensing timing of the resolver, and controls the motor by using the angle of rotation for control.

The resolver may generate the voltage sensing values in a first period, and the motor controller may control the motor in a second period.

The resolver may generate the voltage sensing values in the first period which is formed in accordance with a first PWM (Pulse Width Modulation) signal, and the motor controller may control the motor in the second period which is formed in accordance with a second PWM signal different from the first PWM signal.

The motor controller may control the motor by varying the second period.

The first period and the second period may have the same duration during a first time interval, and the first period and the second period may have different durations during a second time interval.

The resolver may include: a rotor winding positioned on a rotating shaft of the motor; a first stator winding in which a first induced voltage is generated by an electromagnetic field formed in the rotor winding; and a second stator winding in which a second induced voltage is generated by an electromagnetic field formed in the rotor winding; and a resolver calculator that generates the voltage sensing values for the first induced voltage and the second induced voltage by using an ADC (Analog-Digital-Converter) and calculates the angle of rotation of the motor in accordance with the voltage sensing values.

An excitation voltage may be supplied to the rotor winding in accordance with an excitation PWM (Pulse Width Modulation) signal, and the resolver calculator may sense the first induced voltage and the second induced voltage in accordance with a sensing PWM signal which lags behind the excitation PWM signal by a certain amount of time.

The first stator winding and the second stator winding may be arranged so that magnetic fields thereof are orthogonal to each other.

The resolver calculator may include ATO (Angle Tracking Observer) logic, and may calculate the angle of rotation of the motor according to the ATO logic.

Another embodiment of the present disclosure provides a motor controller including: a resolver signal processing unit that obtains, from a resolver, an angle of rotation of the motor and a sensing timing of the resolver; a control value calculating unit that calculates an angle of rotation for control by checking a control timing and extrapolating the angle of rotation calculated by the resolver based on a time difference between the control timing and the sensing timing of the resolver, and that determines a control value for the motor by using the angle of rotation for control; and a control signal output unit that outputs a control signal corresponding to the control value to the motor.

The motor controller may further include an ADC (Analog-Digital-Converter) that senses a control value for the motor, wherein the control value calculating unit checks a sensing timing of the ADC based on the control timing.

At a certain point in time, a sensing period of the resolver and a control period of the control value calculating unit may have different durations.

The control period of the control value calculating unit may vary.

An excitation PWM (Pulse Width Modulation) signal may provide a reference for an excitation voltage of the resolver and a sensing PWM signal may provide a reference for the sensing timing of the stator windings' induced voltages for the excitation voltage, the excitation PWM signal and the sensing PWM signal having a phase difference therebetween.

The stator windings may be arranged so that magnetic fields thereof are orthogonal to each other.

Yet another embodiment of the present disclosure provides a motor control method including: checking a control timing; obtaining, from a resolver, an angle of rotation of the motor and a sensing timing of the resolver; calculating an angle of rotation for control by extrapolating the angle of rotation calculated by the resolver based on a time difference between the control timing and the sensing timing of the resolver; determining a control value for the motor by using the angle of rotation for control; and outputting a control signal corresponding to the control value to the motor.

At a certain point in time, a sensing period of the resolver and a control period for the motor may have different durations.

The control period may vary.

As described above, according to the present disclosure, it is possible to make the angle of rotation of the motor detected at a control timing more analogous to the actual angle of rotation of the motor. Moreover, according to the present disclosure, the stability of motor control can be enhanced, and torque ripple in the motor can be minimized.

### BRIEF DESCRIPTION OF THE DRAWINGS

FIG. 1 is a configuration diagram of a motor device according to an embodiment.

FIG. 2 is a configuration diagram of a resolver according to an embodiment.

FIG. 3 is a view showing main waveforms of a resolver according to an embodiment.

FIG. 4 is a configuration diagram of a motor controller according to an embodiment.

FIG. 5 is a view showing main waveforms of a motor controller and a resolver, according to an embodiment.

FIG. 6 is a view showing an extrapolation process according to an embodiment.

FIG. 7 is a flowchart of a motor control method according to an embodiment.

FIG. 8 is a view showing a motor output waveform when a control value is calculated without extrapolation.

FIG. 9 is a view showing a motor output waveform when a control value is calculated using extrapolation according to an embodiment.

### DETAILED DESCRIPTION

Hereinafter, some embodiments of the present disclosure are described in detail with reference to the accompanying drawings. With regard to the reference numerals of the components of the respective drawings, it should be noted that the same reference numerals are assigned to the same components even when the components are shown in different drawings. In addition, in describing the present disclosure, detailed descriptions of well-known configurations or functions have been omitted in order not to obscure the gist of the present disclosure.

In addition, terms such as “1st”, “2nd”, “A”, “B”, “(a)”, “(b)”, or the like may be used in describing the components of the present disclosure. These terms are intended only for distinguishing a corresponding component from other components, and the nature, order, or sequence of the corresponding component is not limited to the terms. In the case where a component is described as being “coupled”, “combined”, or “connected” to another component, it should be understood that the corresponding component may be directly coupled or connected to another component or that the corresponding component may also be “coupled”, “combined”, or “connected” to the component via another component provided therebetween.

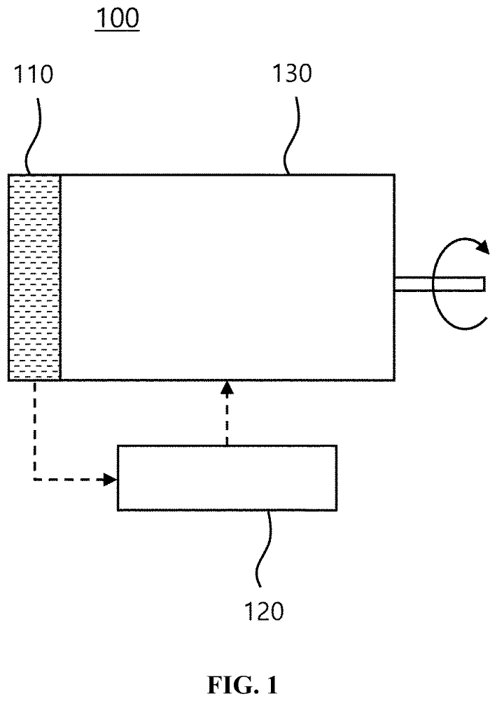

FIG. 1 is a configuration diagram of a motor device according to an embodiment.

Referring to FIG. 1, the motor device 100 may include a motor 130, a motor controller 120, and a resolver 110.

The motor 130 may be a permanent magnet synchronous motor.

A permanent magnet synchronous motor (PMSM) is a type of electric motor that offers high efficiency and superior performance, which is widely used in various fields such as eco-friendly vehicles, industrial machinery, and home appliances. The PMSM includes a stator and a rotor. The stator has armature windings, while the rotor has permanent magnets. The motor operates through electromagnetic interaction, and is suitable for precise position control and high-speed operation.

The working principle of PMSMs is that the rotor rotates in synchronization with the stator's rotating magnetic field. When alternating current (AC) is applied to the windings in the stator, a rotating magnetic field is generated. This magnetic field interacts with the permanent magnets in the rotor, causing the rotor to rotate. During this process, the rotor rotates at a speed that is synchronized with the stator's magnetic field. As a result, the PMSM can maintain a constant rotational speed with minimal variation, even under changing load conditions.

PMSMs offer high energy efficiency. Since they utilize permanent magnets, a magnetic field can be created without supply of external electrical power, which helps reduce energy loss and improve efficiency. Moreover, PMSMs provide a high torque density and have the advantages of being compact and lightweight. These characteristics are very crucial in means of transportation such as electric vehicles.

PMSMs provide high-precision control. They are widely used in applications that require precise motion control because their ability to accurately control position and speed. To this end, position detectors such as the resolver 110 are employed, and these devices sense the exact position of the rotor and provide feedback to a control system.

The motor controller 120 is an electronic device that controls and optimizes the operation of the motor 130. It enables efficient and precise operation of the motor in various applications by controlling the motor's speed, position, and torque.

The motor controller 120 includes a Micro-Controller Unit (MCU) or a Digital Signal Processor (DSP). It receives input signals from various sensors to monitor the status of the motor 130 and generate control signals. For example, the motor controller 120 reads a position sensing value or a speed sensing value from the resolver 110, and based on this value, produces a control signal to control the speed or position of the motor 130.

A power conversion device may be incorporated into either the motor 130 or the motor controller 120. The power conversion device adjusts voltage and current in accordance with the control signals generated by the motor controller 120, thereby controlling the speed and torque of the motor (130).

The resolver 110 is capable of calculating the position, speed, and angle of rotation of the motor 130. Also, the resolver 110 may transmit a calculated value to the motor controller 120.

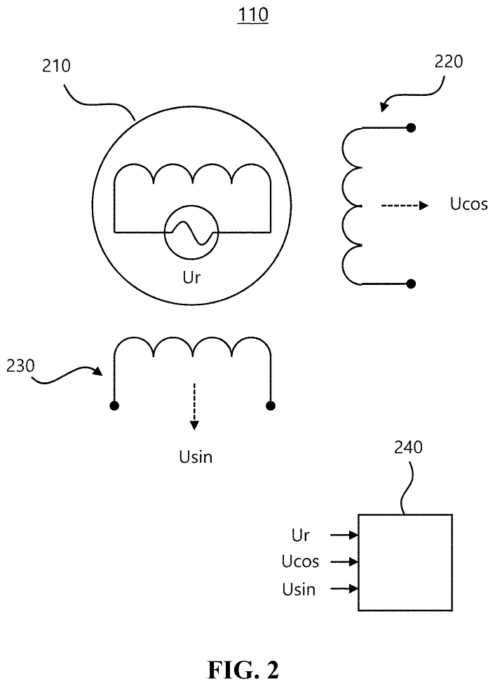

FIG. 2 is a configuration diagram of a resolver according to an embodiment.

Referring to FIG. 2, the resolver 110 may include a rotor winding 210, a first stator winding 220, a second stator winding 230, and a resolver calculator 240.

The rotor winding 210 may be positioned on a rotating shaft of the motor. The rotor winding 210 may rotate along with the rotor of the motor at the same speed as the motor's rotor or at a speed that is either decreased or increased by a certain ratio.

An excitation voltage Ur may be supplied to the rotor winding 210. The excitation voltage Ur is an alternating current voltage that can create a varying electromagnetic field in the rotor winding 210. As the rotor winding 210 rotates, the electromagnetic field also may rotate accordingly.

The first stator winding 220 may be a stationary coil. Due to the electromagnetic field generated in the rotor winding 210, a first induced voltage Ucos may be generated in the first stator winding 220. The first induced voltage Ucos may take the form of an alternating current voltage, and this voltage may be defined as a cosine voltage.

The second stator winding 230 may be a stationary coil. Due to the electromagnetic field generated in the rotor winding 210, a second induced voltage Usin may be generated in the second stator winding 230. The second induced voltage Usin may take the form of an alternating current voltage, and this voltage may be defined as a sine voltage.

The first stator winding 220 and the second stator winding 230 may be arranged so that their magnetic fields are orthogonal to each other. With this arrangement, the first induced voltage Ucos may be defined as a cosine voltage, while the second induced voltage Usin may take the form of a sine voltage whose waveform has a phase difference of 90 degrees relative to the first induced voltage Ucos.

The resolver calculator 240 uses an ADC (Analog-Digital Converter) to generate voltage sensing values for the first induced voltage Ucos and the second induced voltage Usin and calculate the position, speed, and angle of rotation of the motor based on the voltage sensing values.

The resolver calculator 240 may calculate the position, speed, and angle of rotation of the motor using a trigonometric-function method. The resolver calculator 240 may include ATO (Angle Tracking Observer) logic and calculate the position, speed, and angle of rotation of the motor according to the ATO logic.

An excitation voltage Ur is supplied to the rotor winding 210 in accordance with an excitation PWM (Pulse Width Modulation) signal, and the resolver calculator 240 may sense the first induced voltage Ucos and the second induced voltage Usin in accordance with a sensing PWM signal which lags behind the excitation PWM signal by a certain amount of time.

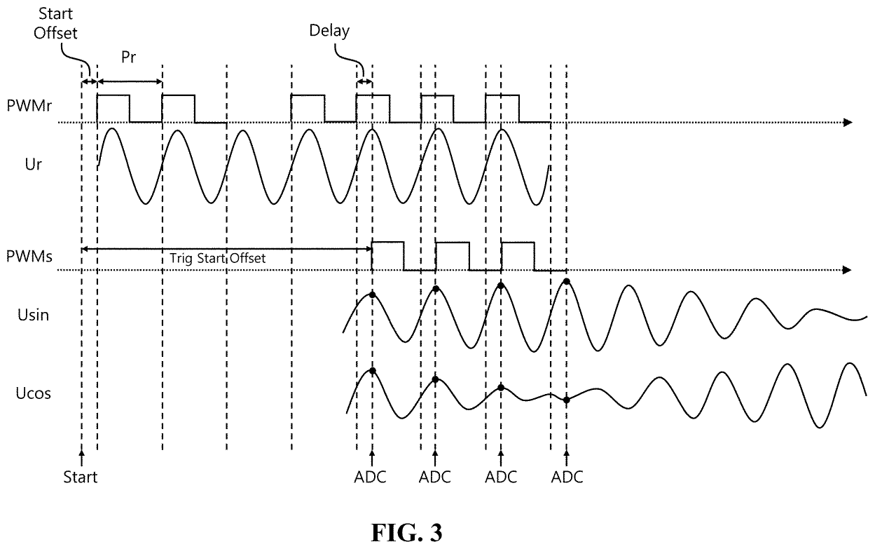

FIG. 3 is a view showing main waveforms of a resolver according to an embodiment.

Referring to FIG. 3, when the resolver starts operating, it may generate an excitation PWM signal PWMr with a given offset time (Start Offset).

The resolver may generate an excitation voltage Ur in synchronization with the period Pr of the excitation PWM signal PWMr. The excitation voltage Ur may be an alternating voltage in the form of a sinusoidal waveform.

After a few periods Pr elapse after the generation of the excitation PWM signal PWMr, a sensing PWM signal PWMs may be generated. The resolver may generate a sensing PWM signal PWMs using a certain time offset (Trig Start Offset). The sensing PWM signal PWMs may be generated a few periods Pr later than the excitation PWM signal PWMr.

The period of the sensing PWM signal PWMs may be of the same length as the period of the excitation PWM signal PWMr. However, there may be a certain phase difference (Delay) between the sensing PWM signal PWM2 and the excitation PWM signal PWMr. The peaks of the first induced voltage Ucos and the second induced voltage Usin, induced by the excitation voltage Ur, do not align with the rising edge of the excitation PWM signal PWMr but appear after a certain delay. To sense the peaks of the first induced voltage Ucos and the second induced voltage Usin, the resolver may generate a sensing PWM signal PWMs after a certain time delay.

The excitation PWM signal PWMr may provide a reference for an excitation voltage Ur of the resolver. The resolver may generate the excitation voltage Ur in accordance with the excitation PWM signal PWMr. Meanwhile, the sensing PWM signal PWMs may provide a reference for the sensing timing of the stator windings' induced voltages Ucos and Usin. The resolver may sense the induced voltages Ucos and Usin at the rising edge of the sensing PWM signal PWMs by using an ADC.

The resolver may calculate the position, speed, and angle of rotation of the motor by using the sensed induced voltages Ucos and Usin. In this case, the resolver may calculate the position, speed, and angle of rotation of the motor in accordance with the sensing PWM signal PWMs.

There may be a time difference between the timing of the sensing PWM signal PWMs and the timing at which the motor controller performs control using the sensing values (position, speed, angle of rotation, etc.). Such a time difference may be generated by several factors. For example, if the motor controller performs control with the same period as the excitation PWM signal PWMr, the above time difference may be generated between the above excitation PWM signal PWMr and sensing PWM signal PWMs due to their phase positions. Also, the above time difference may be generated when the resolver generates the sensing values (position, speed, angle of rotation, etc.) in a first period and when the motor controller controls the motor in a second period which is different from the first period.

If a time difference occurs between the sensing timing and the control timing, a control instability factor such as torque ripple may arise.

As previously described, the resolver calculates the angle of rotation of the motor based on voltage sensing values Ucos and Usin from the stator windings. However, there may be a time difference between the control timing and the voltage sensing timing of the resolver. Thus, the motor controller may recalculate the angle of rotation for control by checking the time difference and extrapolating the angle of rotation calculated by the resolver. The motor controller may control the motor by using the angle of rotation for control.

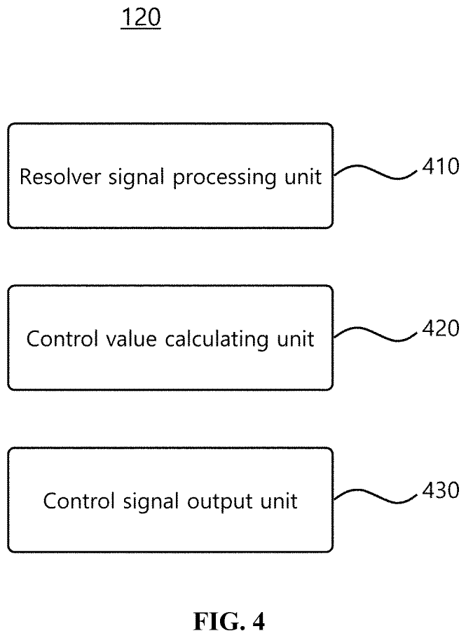

FIG. 4 is a configuration diagram of a motor controller according to an embodiment.

Referring to FIG. 4, the motor controller 120 may include a resolver signal processing unit 410, a control value calculating unit 420, and a control signal output unit 430.

The resolver signal processing unit 410 may obtain, from a resolver, an angle of rotation of the motor and a sensing timing of the resolver. The angle of rotation and the sensing timing may be obtained using shared memory or through communication.

The control value calculating unit 420 may calculate an angle of rotation for control by checking a control timing for motor control and extrapolating the angle of rotation calculated by the resolver based on a time difference between the control timing and the sensing timing.

Also, the control value calculating unit 420 may determine a control value for the motor by using the angle of rotation for control.

Also, the control signal output unit 430 may output a control signal corresponding to the determined control value to the motor.

The motor controller 120 may further include an ADC for sensing a control value for the motor. The motor controller 120 may sense the voltage or current of a power conversion device that supplies electric power to the motor by using the ADC.

The control value calculating unit 420 may check a sensing timing of the ADC based on the above control timing.

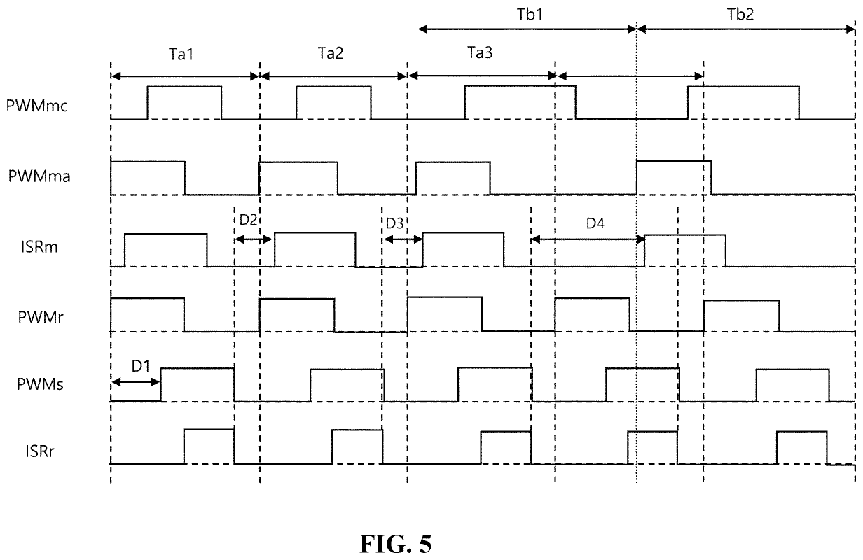

FIG. 5 is a view showing main waveforms of a motor controller and a resolver, according to an embodiment.

Referring to FIG. 5, a control PWM signal PWMmc for determining a control period may be generated.

The motor controller may generate a control PWM signal PWMmc during a first control period Ta1, Ta2, and Ta3.

Also, a control ADC signal PwMma having the same period duration as the control PWM signal PWMmc may be generated. The motor controller may sense values required for control in accordance with the control ADC signal PWMma. Also, the motor controller may determine the control timing in accordance with the control ADC signal PWMma.

The motor controller's Interrupt Service Routine (ISRm) may be invoked in accordance with the control ADC signal PWMma. Also, the ISR (ISRm) of the motor controller may calculate a control value for controlling the motor.

The motor controller may calculate a control value for controlling the motor by using the position, speed, and angle of rotation of the motor calculated by the resolver.

The resolver may generate an excitation PWM signal PWMr and a sensing PWM signal PWMs. The resolver may generate an excitation PWM signal PWMr and a sensing PWM signal PWMs so as to have the same control period Ta1, Ta2, and Ta3 as the control PWM signal PWMmc generated by the motor controller. In this case, the control PWM signal PWMmc, the excitation PWM signal PWMr, and the sensing PWM signal PWMs may have a phase difference D1.

The ISR (ISRr) of the resolver may be invoked in accordance with the sensing PWM signal PWMs. Also, the ISR (ISRr) of the resolver may calculate the position, speed, and angle of rotation of the motor.

However, there may be time differences D2, D3, and D4 between the timings at which the resolver ISR (ISRr) and the motor controller ISR (ISRm) are invoked. As previously described, these time differences D2, D3, and D4 may arise due to phase differences among the control PWM signal PWMmc, the excitation PWM signal PWMr, and the sensing PWM signal PWMs.

These time differences D2, D3, and D4 may cause torque ripple and destabilize control.

Meanwhile, the motor controller may vary the control period. The motor controller may change the control period from a first period Ta1 and Ta2 to a second period Tb1 and Tb2. In this case, since the resolver may not change the period, the time difference between the timings at which the resolver ISR (ISRr) and the motor controller ISR (ISRm) are invoked may become larger. For example, the time difference D4 observed in the second control period Tb1 and Tb2 may be greater than the time difference D2 observed in the first control period Ta1 and Ta2.

In this way, the resolver may generate voltage sensing values in the first period, e.g., the first control period, while the motor controller may control the motor in the second period, e.g., the second control period. Here, the first period may be formed in accordance with the sensing PWM signal PWMs, and the second period may be formed in accordance with the control ADC signal PWMma.

The motor controller may control the motor by varying the second period. Accordingly, during a first time interval, for example, Ta1 and Ta2, the first and second periods may have the same duration, and, during a second time interval, for example, Tb1 and Tb2, the first and second periods may have different durations.

To address the issues caused by these time differences, the motor controller may extrapolate the values obtained from the resolver.

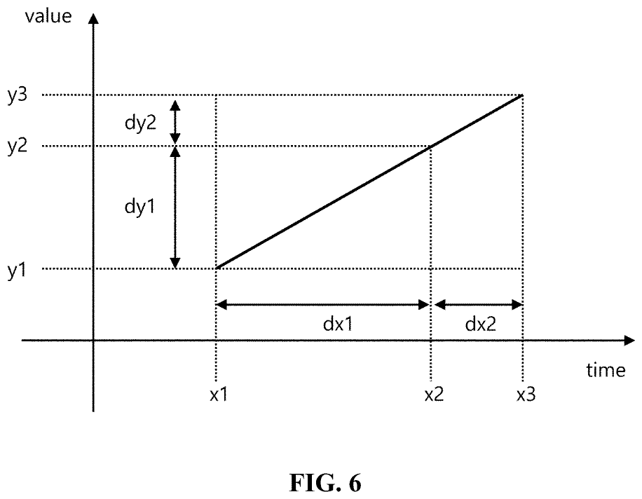

FIG. 6 is a view showing an extrapolation process according to an embodiment.

Referring to FIG. 6, the motor controller may extrapolate a sensing value calculated by the resolver based on time.

The motor controller may check a resolver sensing value y2 and a resolver sensing timing x2 that are currently obtained.

Also, the motor controller may check a resolver sensing value y1 and a resolver sensing timing x1 that are previously obtained and stored.

Also, the motor controller may calculate a control sensing value y3 to be used at a current control timing x3 by using an extrapolation method, as shown in Mathematical Expression 1:

$$dy 2 = dx 2 ( dy 1 / dx 1 ) \qquad [ Mathematical Expression 1 ]$$

$$y 3 = y 2 + dy 2$$

$$dx 2 = x 3 - x 2 , dy 1 = y 2 - y 1 , dx 1 = x 2 - x 1$$

$$y 3 = y 2 + ( x 3 - x 2 ) ( y 2 - y 1 ) / ( x 2 - x 1 )$$

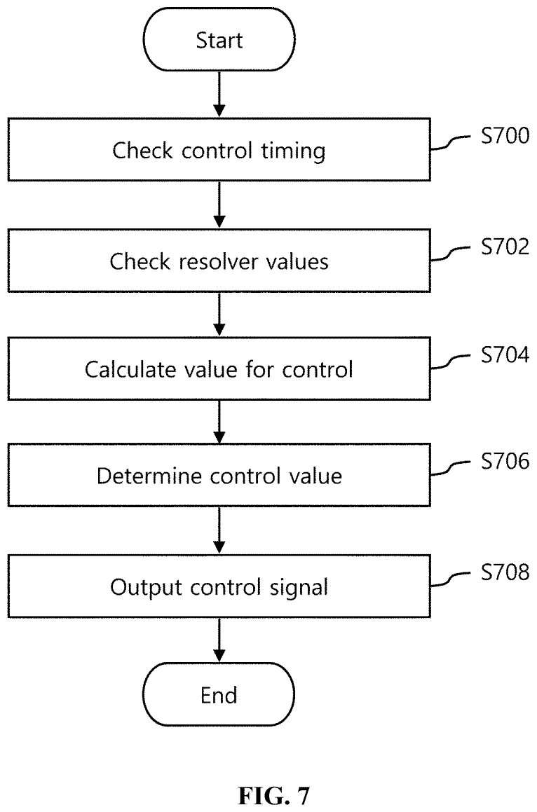

FIG. 7 is a flowchart of a motor control method according to an embodiment.

Referring to FIG. 7, the motor controller may check a control timing (S700).

Also, the motor controller may obtain an angle of rotation of the motor from a resolver and a sensing timing of the resolver (S702).

The motor controller may calculate an angle of rotation for control by extrapolating the angle of rotation calculated by the resolver based on a time difference between the control timing and the sensing timing of the resolver (S704).

Then, the motor controller may determine a control value for the motor by using the angle of rotation for control (S706).

Then, the motor controller may output a control signal to the motor in accordance with the control value (S708).

At a certain point in time, a sensing period of the resolver and a control period for the motor may have different durations.

Also, the control period may vary.

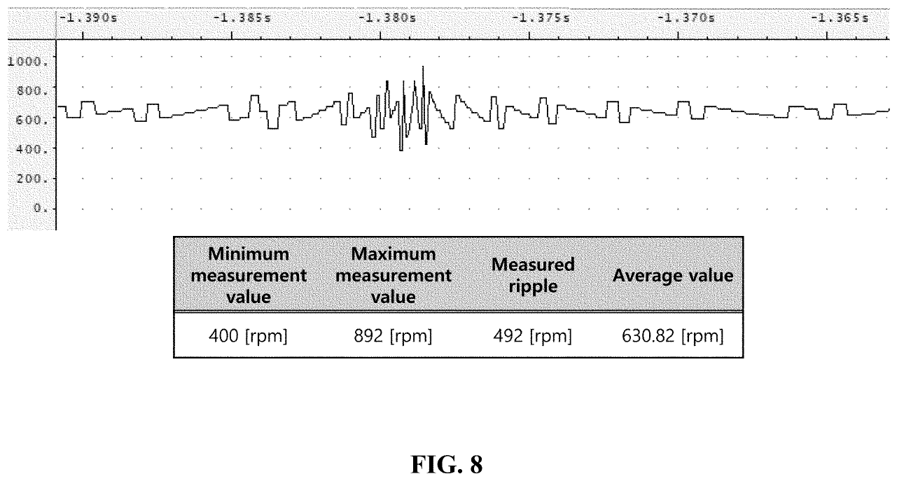

FIG. 8 is a view showing a motor output waveform when a control value is calculated without extrapolation.

As can be seen from FIG. 8, when extrapolation was not applied, a very large ripple (492 rpm) was measured, corresponding to the difference between the maximum measurement value (892 rpm) of motor output and the minimum measurement value (400 rpm) of motor output.

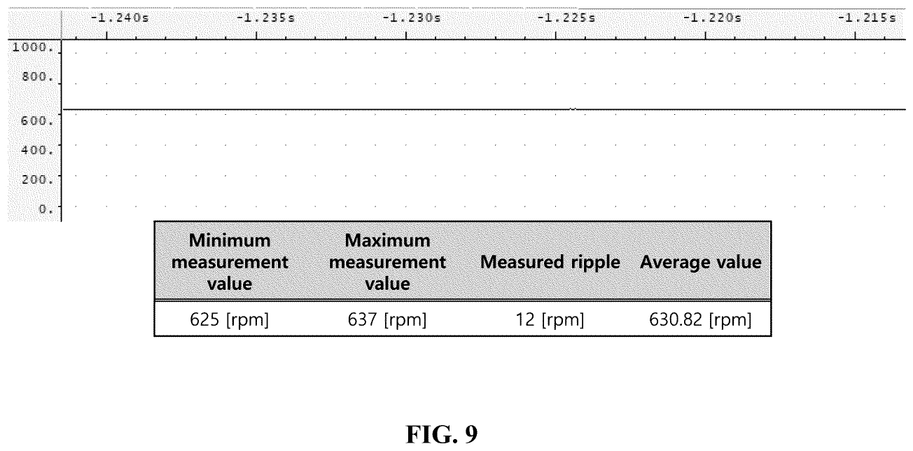

FIG. 9 is a view showing a motor output waveform when a control value is calculated using extrapolation according to an embodiment.

As shown in FIG. 9, when extrapolation was applied, a very small ripple (12 rpm) was measured, corresponding to the difference between the maximum measurement value (637 rpm) of motor output and the minimum measurement value (625 rpm) of motor output.

As described above, according to the present disclosure, it is possible to make the angle of rotation of the motor detected at a control timing more analogous to the actual angle of rotation of the motor. Moreover, according to the present disclosure, the stability of motor control can be enhanced, and torque ripple in the motor can be minimized.

The terms “include,” “comprise,” or “have” as used herein, unless otherwise specifically stated, imply that the corresponding component may be included, and therefore should be interpreted as including other components rather than excluding other components. All terms, including technical or scientific terms, unless otherwise defined, have the same meaning as commonly understood by a person of ordinary skill in the art to which this disclosure pertains. Commonly used terms, such as terms defined in a dictionary, should be interpreted as being consistent with their contextual meaning in the relevant art, and shall not be interpreted in an idealistic or overly formal sense, unless expressly defined in the present disclosure.

The above description is merely an illustrative description of the technical idea of the present disclosure, and those skilled in the art will appreciate that various modifications and variations may be made without departing from the essential characteristics of the present disclosure. Accordingly, the embodiments disclosed in the present disclosure are not intended to limit the technical idea of the present disclosure but to explain it, and the scope of the technical idea of the present disclosure is not limited by these embodiments. The protection scope of the present disclosure should be interpreted by the following claims, and all technical ideas within a scope equivalent thereto should be interpreted as being included in the scope of the rights of the present disclosure.

What is claimed is:

1. A motor control device comprising:
a resolver to calculate an angle of rotation of a motor in accordance with voltage sensing values from stator windings; and
a motor controller to calculate an angle of rotation for control by extrapolating the angle of rotation calculated by the resolver based on a time difference between a control timing and a voltage sensing timing of the resolver and to control the motor by using the angle of rotation for control.

2. The motor control device of claim 1, wherein the resolver generates the voltage sensing values in a first period, and the motor controller controls the motor in a second period.

3. The motor control device of claim 2, wherein the resolver generates the voltage sensing values in the first period in accordance with a first Pulse Width Modulation (PWM) signal, and the motor controller controls the motor in the second period formed in accordance with a second PWM signal different from the first PWM signal.

4. The motor control device of claim 2, wherein the motor controller controls the motor by varying the second period.

5. The motor control device of claim 2, wherein the first period and the second period have a same duration during a first time interval, and the first period and the second period have different durations during a second time interval.

6. The motor control device of claim 1, wherein the resolver includes:
a rotor winding positioned on a rotating shaft of the motor;
a first stator winding in which a first induced voltage is generated by an electromagnetic field formed in the rotor winding;
a second stator winding in which a second induced voltage is generated by an electromagnetic field formed in the rotor winding; and
a resolver calculator to generate the voltage sensing values for the first induced voltage and the second induced voltage by using an Analog-Digital-Converter (ADC) and to calculate the angle of rotation of the motor in accordance with the voltage sensing values.

7. The motor control device of claim 6, wherein an excitation voltage is supplied to the rotor winding in accordance with an excitation PWM signal, and the resolver calculator senses the first induced voltage and the second induced voltage in accordance with a sensing PWM signal which lags behind the excitation PWM signal by a certain amount of time.

8. The motor control device of claim 6, wherein the first stator winding and the second stator winding are arranged to have a magnetic field of the first stator winding and a magnetic field of the second stator winding orthogonal to each other.

9. The motor control device of claim 6, wherein the resolver calculator includes an Angle Tracking Observer (ATO) logic, and calculates the angle of rotation of the motor according to the ATO logic.

10. A motor controller comprising:
a resolver signal processing unit to obtain, from a resolver, an angle of rotation of a motor and a sensing timing of the resolver;
a control value calculating unit to calculate an angle of rotation for control by checking a control timing and extrapolating the angle of rotation calculated by the resolver based on a time difference between the control timing and the sensing timing of the resolver, and the control value calculating unit to determine a control value for the motor by using the angle of rotation for control; and
a control signal output unit to output a control signal corresponding to the control value for the motor.

11. The motor controller of claim 10, further comprising an ADC to sense the control value for the motor,
wherein the control value calculating unit checks a sensing timing of the ADC based on the control timing.

12. The motor controller of claim 10, wherein, at a certain point in time, a sensing period of the resolver and a control period of the control value calculating unit have different durations.

13. The motor controller of claim 12, wherein the control period of the control value calculating unit is varied.

14. The motor controller of claim 10, wherein an excitation PWM signal provides a reference for an excitation voltage of the resolver and a sensing PWM signal provides a reference for the sensing timing of induced voltages of stator windings for the excitation voltage, the excitation PWM signal and the sensing PWM signal having a phase difference therebetween.

15. The motor controller of claim 14, wherein the stator windings are arranged to have magnetic fields of the stator windings orthogonal to each other.

16. A motor control method comprising:
checking a control timing;
obtaining, from a resolver, an angle of rotation of a motor and a sensing timing of the resolver;
calculating an angle of rotation for control by extrapolating the angle of rotation obtained by the resolver based on a time difference between the control timing and the sensing timing of the resolver;
determining a control value for the motor by using the angle of rotation for control; and
outputting a control signal corresponding to the control value for the motor.

17. The motor control method of claim 16, wherein, at a certain point in time, a sensing period of the resolver and a control period for the motor have different durations.

18. The motor control method of claim 17, wherein the control period is varied.
